(19) United States
(12) Patent Application Publication
(10) Pub. No.: US 2025/0151783 A1
(43) Pub. Date: May 15, 2025

(54) A CASE FOR AN AEROSOL DELIVERY DEVICE

(71) Applicant: NICOVENTURES TRADING LIMITED, London (GB)

(72) Inventors: Sam LAI, London (GB); Tomi VINTOLA, London (GB); Rick YANG, Taipei City (CN)

(21) Appl. No.: 18/837,584

(22) PCT Filed: Feb. 10, 2023
(86) PCT No.: PCT/GB2023/050314

§ 371 Date: Aug. 10, 2024

(30) Foreign Application Priority Data
Feb. 11, 2022 (GB) 2201810.5

(51) Int. Cl. A24F 15/01; A24F 40/95; H04Q 9/00

(52) U.S. Cl. CPC A24F 15/01; A24F 40/95; H04Q 9/00

(57) ABSTRACT

A case for an aerosol delivery device is described. The case comprises a lid, an accelerometer (for detecting movement indicative of the lid position changing from a closed position to an open position), a battery status indicator, and a controller. The controller is configured to activate the battery status indicator when said signal indicates that the lid position has changed from the closed position to the open position.

### TECHNICAL FIELD

The present specification relates to a case (e.g. a carry case), in particular a case for an aerosol delivery device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol delivery device may be provided with a case, such as a carry case, for retaining the device when not in use. There remains a need for further developments in this field.

### SUMMARY

In a first aspect, this specification describes a case for an aerosol delivery device. The case comprises: a lid having an open position and a closed position; an accelerometer configured to detect movement indicative of the lid position changing from the closed position to the open position; a battery status indicator (e.g. comprising one or more light emitting diodes); and a controller configured to activate the battery status indicator when said signal indicates that the lid position has changed from the closed position to the open position. The controller may be configured to receive a signal from the accelerometer indicative of the lid position changing from the closed position to the open position.

In some example embodiments, the accelerometer is provided within the lid of the case. Alternatively, the accelerometer may be provided within a main body of the case.

The battery status indicator may indicate a charge level of the case. Alternatively, or in addition, the battery status indicator may indicate a charge level of an aerosol delivery device received in the case.

The movement indicative of the lid position changing from the closed position to the open position may be detected by processing data from the accelerometer.

The movement indicative of the lid position changing from the closed position to the open position may be detected by processing data from the accelerometer using a machine learning model. The said machine learning model may be provided as part of the accelerometer. Alternatively, the said machine learning model may be provided as part of the controller.

In a second aspect, this specification describes a method comprising: receiving movement data from an accelerometer comprised in a case for an aerosol delivery device; determining whether the movement data are indicative of a lid position changing from a closed position to an open position; and activating a battery status indicator of the case in the event that the movement data are determined to be indicative of the lid position changing from a closed position to an open position. The method may further comprise receiving or generating a signal from the accelerometer indicative of the lid position changing from the closed position to the open position.

In some example embodiments, the accelerometer is provided within the lid of the case. Alternatively, the accelerometer may be provided within a main body of the case.

The battery status indicator may indicate a charge level of the case and/or a charge level of an aerosol delivery device received in the case.

The method may further comprise processing data from the accelerometer to generate a signal indicative of the lid position changing from the closed position to the open position.

The method may further comprise using a machine learning model to process data from the accelerometer to generate a signal indicative of the lid position changing from the closed position to the open position.

In a third aspect, this specification describes a method comprising: receiving movement data from an accelerometer comprised in a case for an aerosol delivery device; and training a machine learning model to detect, based on the received movement data, movement indicative of a lid of the case changing from a closed position to an open position, wherein the case comprises the lid having the open position and the closed position, the accelerometer, a battery status indicator, and a controller to activate the battery status indicator in the event that the movement data are determined to be indicative of the lid position changing from a closed position to an open position. In some example embodiments, the accelerometer is provided within the lid of the case. Alternatively, the accelerometer may be provided within a main body of the case. The battery status indicator may indicate a charge level of the case and/or a charge level of an aerosol delivery device received in the case.

In a fourth aspect, this specification describes a kit of parts comprising a case as defined in the first aspect, an aerosol delivery device and an article for use in the aerosol delivery device. The aerosol delivery device may be a non-combustible aerosol generating device. The article may be a removable article comprising an aerosol generating material.

### BRIEF DESCRIPTION OF THE DRAWINGS

Example embodiments will now be described, by way of example only, with reference to the following schematic drawings, in which:

FIG. 1 shows a case for an aerosol delivery device in accordance with an example embodiment;

FIG. 2 is a block diagram of a non-combustible aerosol delivery device in accordance with an example embodiment;

FIG. 3 is a flow chart showing an algorithm in accordance with an example embodiment;

FIG. 4 is a block diagram of a system in accordance with an example embodiment;

FIG. 5 is a block diagram of a system in accordance with an example embodiment;

FIG. 6 is a flow chart showing an algorithm in accordance with an example embodiment;

FIGS. 7 to 9 are block diagrams of displays in accordance with example embodiments;

FIGS. 10 to 12 are flow charts showing algorithms in accordance with example embodiments; and

FIG. 13 is a block diagram of a neural network in accordance with an example embodiment.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine. In some embodiments, the active substance comprises caffeine, melatonin or so vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support so may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

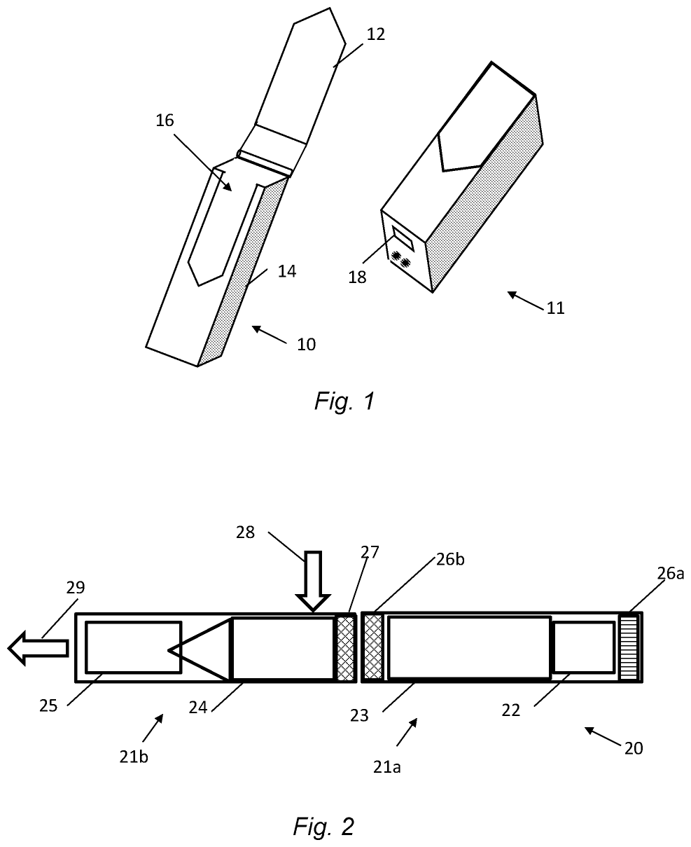

FIG. 1 shows a case for an aerosol delivery device, indicated generally by the reference numeral 10, in accordance with an example embodiment. The case 10 comprises a lid 12 and a main body 14. The main body 14 includes a storage area 16 for storing an aerosol delivery device (not shown in FIG. 1). The aerosol delivery device may be a non-combustible aerosol generating device, although this is not essential to all example embodiments.

As shown in an alternative orientation 11 of case 10, the case 10 further includes a port 18 that may be used for charging a battery of an aerosol delivery device stored in the storage area 16 or for charging a battery of the case 10. In one example embodiment, the battery of the case may be used to charge a battery of an aerosol delivery device stored in the storage area 16.

FIG. 2 is a block diagram of a non-combustible aerosol delivery device, indicated generally by the reference numeral 20, in accordance with an example embodiment. The aerosol delivery device 20 (or a part thereof) may be stored within the area 16 of the case 10 described above. The device 20 is a modular device, comprising a first part 21a and a second part 21b. In some embodiments, the first part 21a and the second part 21b may be stored separately in the case 10 (e.g. detached from one another). The so aerosol delivery device 20 may comprise a tobacco heating system.

The first part 21a of the device 20 includes a control circuit 22 and a battery 23. The second part 21b of the device 20 includes a heater 24 and a liquid reservoir 25 (that may collectively form an aerosol generator).

The first part 21a includes a first connector 26a (such as a USB connector). The first connector 26a may enable connection to be made to a power source (e.g. a battery of the case 10 or an external power supply via the port 18 of the case 10) for charging the battery 23, for example under the control of the control circuit 22.

The first part 21a also includes a second connector 26b that can be removably connected to a first connector 27 of the second part 21b.

In the use of the device 20, air is drawn into an air inlet of the heater 24, as indicated by the arrow 28. The heater is used to heat the air (e.g. under the control of the control circuit 22). The heated air is directed to the liquid reservoir 25, where an aerosol is generated. The aerosol exits the device at an air outlet, as indicated by the arrow 29 (for example into the mouth of a user of the device 20).

The liquid reservoir 25 may be provided by a removable article comprising an aerosol generating material. The aerosol generating material may comprise an aerosol generating substrate and an aerosol forming material.

It should be noted that the device 20 is described by way of example only. Many alternative devices could be stored within the case 10 in accordance with example embodiments.

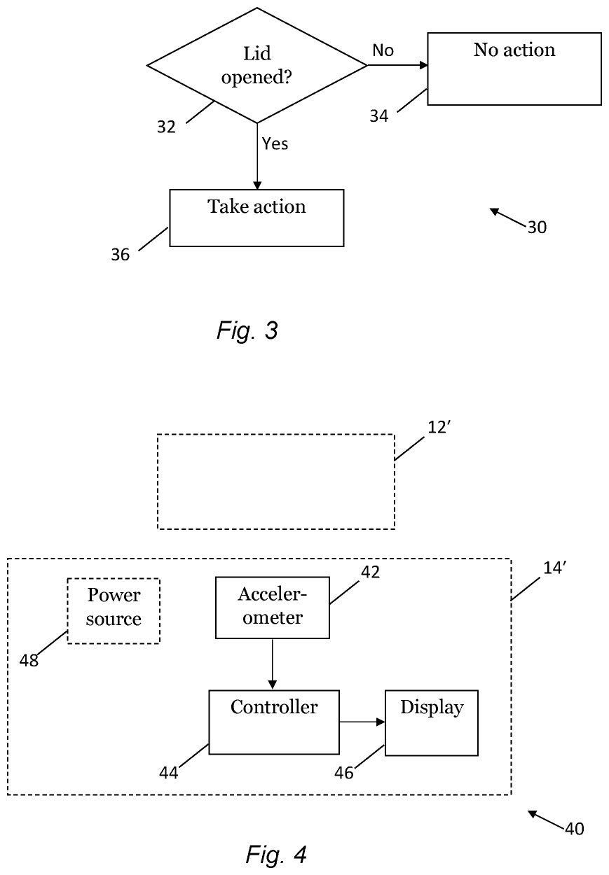

FIG. 3 is a flow chart showing an algorithm, indicated generally by the reference numeral 30, in accordance with an example embodiment.

The algorithm 30 starts at operation 32, where a determination is made regarding whether the lid 12 of the case 10 has been opened. If not, the algorithm 30 moves to operation 34 where no action is taken. The algorithm 30 may then terminate, or may return to the operation 32.

If it is determined in the operation 32 that the lid has been opened, then the algorithm moves to operation 36 where action is taken in response to the opening of the lid. Example actions are discussed further below.

Of course, the algorithm 30 shown in FIG. 3 is highly schematic and may be implemented in many different ways. For example, the algorithm 30 may be implemented as an interrupt routine, wherein the detection of the lid changing from a closed state to the opened state triggers the operation 36 (where action is taken).

FIG. 4 is a block diagram of a system, indicated generally by the reference numeral 40, in accordance with an example embodiment.

The system 40 comprises an accelerometer 42, a controller 44, a display 46 and a power source 48. The accelerometer 42, the controller 44, the display 46 and the power source 48 may be within the main body 14 of the case 10 (as indicated by the dotted box 14′ in FIG. 4).

The display 46 is used as a battery status indicator, as discussed further below. The display 46 may indicate a charge level of the case 10 and/or a charge level of an aerosol delivery device received within the case.

The accelerometer 42 is configured to detect movement indicative of the lid 12 being opened, as discussed further below.

In one example embodiment, the accelerometer 42 is comprised within the main body 14, and therefore would detect any movement in the case 10. For example, it may be likely that a user would move the case 10 (e.g. taking the case 10 in their hand) from a stationary position before opening the lid 12, which movement may be detected by the accelerometer 42. Alternatively if the case 10 is already in motion (e.g. if the user is walking or in a vehicle while carrying the case 1o), the accelerometer 42 may detect a further movement (e.g. movement higher than a threshold movement) if the user moves the case 10 before opening the lid. In one example, movement data from the accelerometer 42 may be processed (e.g. at the accelerometer 42, at the controller 44 or elsewhere) in order to estimate whether the movement is indicative of the lid 12 being opened. For example, the processing may be performed using a machine learning model.

The power source 48 (such as a battery) may provide power to the various elements within the main body of the case 10 (such as the accelerometer 42, the controller 44 and the display 46). In some example embodiments, the battery 23 of an aerosol delivery device 20 mounted within the storage area 16 of the case 10 may be used to power the elements within the main body of the case in addition to, or instead of, the power source 48. Indeed in some example embodiments, the power source 48 may be omitted.

As discussed in detail below, the controller 44 is configured to control the display 46.

The controller 44 may be configured to receive a signal from the accelerometer 42. The controller 44 may then activate the battery status indicator (e.g. display 46) when the signal from the accelerometer indicates that the lid position changes from a closed position to an open position. For example, the battery status indicator may be selectively illuminated to provide an indication of a battery status (e.g. the charge level of the relevant battery), as described in further detail below.

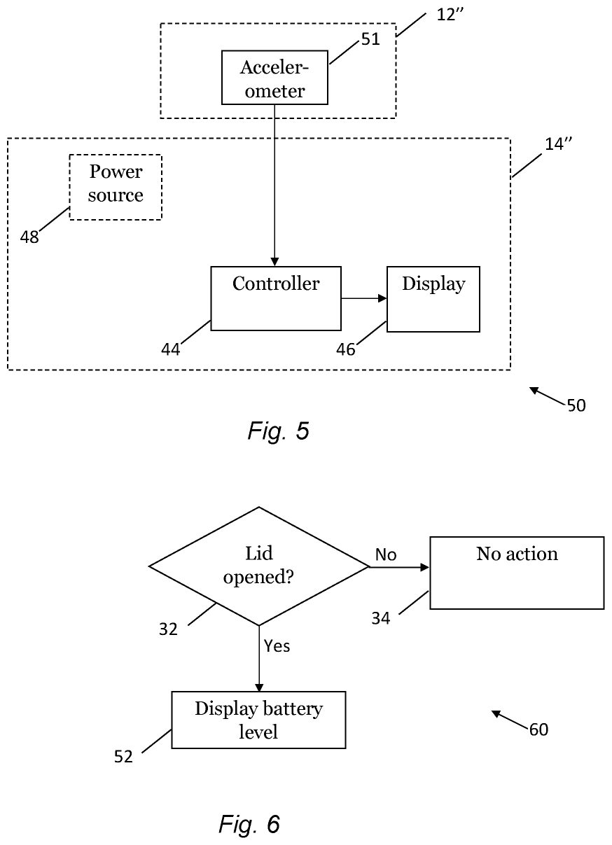

FIG. 5 is a block diagram of a system, indicated generally by the reference numeral 50, in accordance with an example embodiment.

The system 50 comprises an accelerometer 51, a controller 44, a display 46 and a power source 48. The controller 44, the display 46 and the power source 48 may be within the main body 14 of the case 10 (as indicated by the dotted box 14″ in FIG. 5). The accelerometer 51 may be within the lid 12 of the case 10 (as indicated by the dotted box 12″ in FIG. 5). The controller 44, the display 46, and the power source 48 may operate as described above with reference to FIG. 4.

The accelerometer 51 is configured to detect movement indicative of the lid 12 being opened, as discussed further below.

In one example embodiment, the accelerometer 51 is comprised within the lid 12, and therefore would detect any movement in the case 10 as a whole, or any movement in just the lid 12. For example, if a user moves the lid 12 for changing lid position from a closed position to an open position, the accelerometer 51 may detect the movement. Such movement may be indicative of the lid 12 being opened. In one example, so movement data from the accelerometer 51 may be processed in order to estimate whether the movement is indicative of the lid 12 being opened. For example, as the lid 12 is part of the case 10, the accelerometer 51 may also detect movement any time the case 10 is moved, even if the lid 12 is not moved relative to the case 10. As such, the processing of the movement data may be performed, for example, using a machine learning model, to determine whether the lid 12 is being opened.

FIG. 6 is a flow chart showing an algorithm in accordance with an example embodiment.

The algorithm 60 starts at operation 32, where, as discussed above, a determination is made regarding whether the lid 12 of the case 10 has been opened (i.e. changed from a closed position to an open position). That determination may be made by the controller 44, based on the signal from the accelerometer 42 or the accelerometer 51. If not, the algorithm 60 moves to operation 34 where no action is taken. The algorithm 30 may then terminate, or may return to the operation 32.

If it is determined in the operation 32 that the lid has been opened, then the algorithm 50 moves to operation 52 where a battery level is displayed (e.g. using the display 46), thereby implementing operation 36 of the algorithm 30 described above. The battery level may be the state of charge of the power source 48 and/or the battery 23 of the device 20 described above. The operation 52 may continue whilst the lid remains opened. Alternatively, the operation 52 may continue for a defined period of time only, such that the battery display level is only presented for a short period of time after the lid is opened.

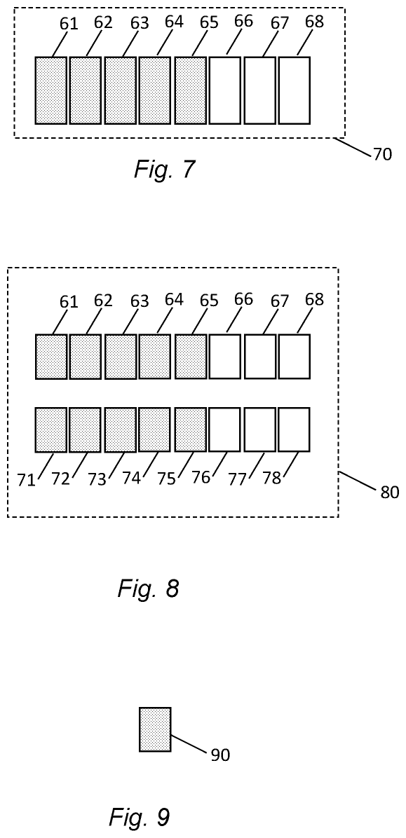

FIG. 7 is a block diagram of a battery status indicator 70. The battery status indicator 70 is an example of the display 46 and may be used to display a battery level, thereby implementing the operation 52 described above.

The battery status indicator 70 comprises a plurality of status indicator elements 61 to 68. The status indicator elements 61 to 68 may, for example, be light emitting diodes (LEDs).

In response to the lid 12 of the case 10 being opened, the indicator elements 61 to 68 so may be selectively illuminated to provide an indication of a battery status (e.g. the charge level of the relevant battery—such as the power source 48 or the battery 23 of the device 20, if present). In this way, battery charge status information can be provided to the user when the case is opened, but does not need to be provided at other times (thereby reducing battery usage). In the example indicator 70, the indicator elements 61 to 65 are illuminated and the indicator elements 66 to 68 are not illuminated.

FIG. 8 is a block diagram of a battery status indicator 80. The battery status indicator 80 is an example of the display 46 and may be used to display a battery level of both the power source 48 and the battery 23 of the device 20 (if present), thereby implementing the operation 52 described above. The battery status indicator 80 comprises the first plurality of status indicator elements 61 to 68 and a second plurality of indicator elements 71 to 78. The first and second status indicator elements may, for example, be light emitting diodes (LEDs).

In response to the lid 12 of the case 10 being opened, the first indicator elements 61 to 68 may be selectively illuminated to provide an indication of a charge level of the power source 48 and the second indicator elements 71 to 78 may be selectively illuminated to provide an indication of a charge level of the battery 23.

The battery status indicators 70 and 80 described above are two example embodiments; many variants are possible. By way of example, FIG. 9 is a block diagram of a battery status indictor 90 that may be used as the display 46 and may be used to display a battery level. The battery status indicator 90 comprises a single LED that can be illuminated in different colours in order to indicate the battery status. For example, the LED of the indictor 9o may be illuminated green if the battery level is good (e.g. above a first threshold), the indicator 90 may be illuminated red if the battery level is poor (e.g. below a second threshold) and the indicator 90 may be illuminated amber if the battery level is neither good nor poor (e.g. between the first and second thresholds). Of course, two LEDs could be provided, with one indicating the status of the power source 48 and the other indicating the status of the battery 23.

In the example embodiments described above, action is taken in response to detecting the opening the lid of the case 10. This is not essential to all example embodiments.

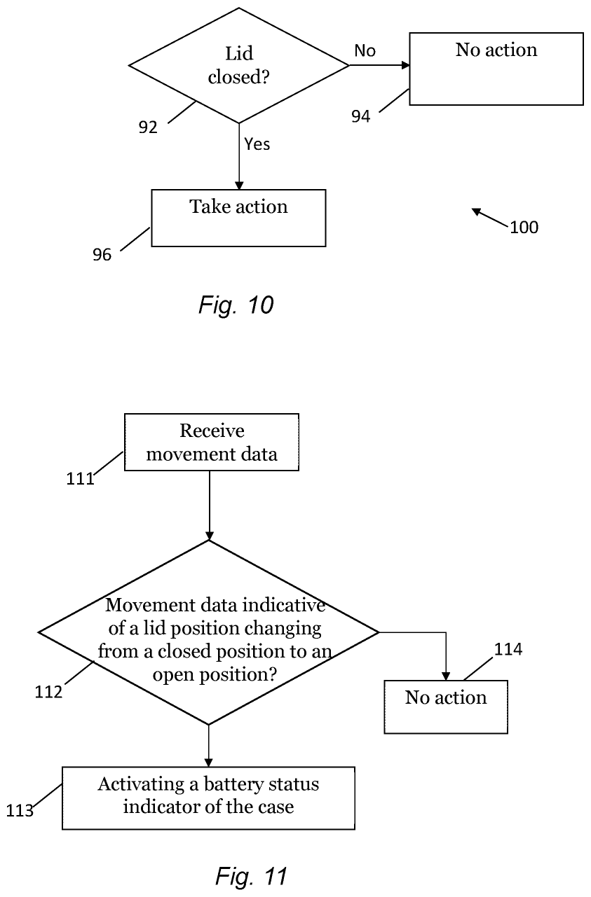

By way of example, FIG. 10 is a flow chart showing an algorithm, indicated generally by the reference numeral 100, in accordance with an example embodiment. The algorithm 100 has many similarities with the algorithm 30 described above.

The algorithm 100 starts at operation 92, where a determination is made regarding whether the lid 12 of the case 10 has been closed. If not, the algorithm 100 moves to operation 94 where no action is taken. The algorithm 100 may then terminate, or may return to the operation 92.

If it is determined in the operation 92 that the lid has been closed, then the algorithm 100 moves to operation 96 where action is taken in response to the opening of the lid (such as providing a battery level indication, as discussed above).

In common with the algorithm 30 described above, the algorithm 100 shown in FIG. 10 is highly schematic and may be implemented in many different ways.

Detection of a movement indicative of the lid 12 being opened (or closed) may be performed in many different ways.

In an example embodiment, the accelerometer(s) 42 and/or 51 (e.g. G-sensor) are capable of measuring acceleration of the case 10, thus detecting movement of the case 10. The accelerometer(s) 42 and/or 51 may also be able to detect orientation of the case (e.g. whether the case 10 is in an orientation suitable for the lid 12 being opened).

In an example embodiment, one or more movement inputs may be predefined, such that if any of the one or more movement inputs are detected by the accelerometer (42, 51), the movement is determined to be indicative of the lid 12 being opened. For example, the one or more movement inputs may be defined based on speed, distance, direction, number of times the movement is performed (e.g. shaking twice), or the like. When the one or more movement inputs are detected, a signal may be sent to the controller 44, such that the controller 44 may activate the battery status indicator.

In an example embodiment, the detection of a movement indicative of the lid 12 being opened is based on a first threshold movement. For example, movement data received from the accelerometer 42 and/or 51 may be compared with the first threshold movement. The first threshold movement may be based on one or more of a movement distance, direction, speed etc.. For example, if movement data received from the accelerometer (42, 51) indicates a small continuous movement or vibration (such as may occur when the user is walking or is in a vehicle while carrying the case 10), the movement may be less than the first threshold movement, which may indicate that the movement is not related to the lid being opened. Alternatively, if the movement data received from the accelerometer (42, 51) indicates a movement determined to be equal to or higher than the first threshold movement when the movement is similar to the case 10 being picked up or the lid 12 being changed from a closed position to an open position (e.g. detected by an accelerometer comprised within the lid 12). Alternatively, or in addition, the direction of movement may be matched with a predefined movement direction. For example, when the accelerometer is comprised within the lid 12, a movement of the lid in a direction away from the main body 14 of the case 10 may indicate the lid being opened.

As such, when the movement is determined to be equal or higher than the first movement threshold, or when the movement direction matches a predefined movement direction, a signal may be sent to the controller 44, such that the controller 44 may activate the battery status indicator when said signal indicates that the lid position changes from a closed position to an open position.

In an example embodiment, a first accelerometer may be provided in the main body 14 of the case 10, and a second accelerometer may be provided in the lid 12 of the case 10. For example, if a movement of the same direction and/or magnitude is detected by both the first and the second accelerometer, it may be determined that the movement is not indicative of the lid 12 being opened, as the movement may relate to the case 10 being moved as a whole. If no movement is detected at the first accelerometer, but a movement is detected at the second accelerometer, it may be determined that the lid 12 moved relative to the case 10, which may be indicative of the lid 12 being opened.

In an example embodiment, the movement indicative of the lid being opened is detected by processing data (e.g. movement data) from the accelerometer using a machine learning model. For example, some movements detected by the accelerometer may be indicative of the lid 12 being opened, while other movements detected by the accelerometer may not be indicative of the lid 12 being opened. As such, a machine learning model may be trained to detect whether a movement is indicative of the lid 12 being opened. The machine learning model may provide an output comprising a signal received by the controller, such that the controller may activate the battery status indicator when said signal indicates that the lid position changes from a closed position to an open position. The machine learning model may be provided at the accelerometer 42, 51, at the controller 42, at both the accelerometer and the controller, or elsewhere.

The comments above relate to determining whether a lid of a case is being opened. Those comments may also be applied to determining whether a lid of a case is being closed.

FIG. 11 is a flowchart of an algorithm, indicated generally by the reference numeral 110, in accordance with an example embodiment. The algorithm 110 starts with operation 111, where movement data is received, for example by the controller 44, from an accelerometer, comprised in the case 10 for an aerosol delivery device. At operation 112, the controller 44 may determine whether the movement data are indicative of a lid position changing from a closed position to an open position. At operation 113, the controller 44 may activate a battery status indicator of the case in the event that the movement data are determined to be indicative of the lid position changing from a closed position to an open position. If it is determined that the movement data is not indicative of the lid position changing from a closed position to an open position, then the algorithm may proceed to operation 114, where no action is taken.

In one example, the controller may receive a signal from the accelerometer indicative of the lid position changing from the closed position to the open position. Alternatively, the controller may receive or generate a signal indicative of the lid position changing from the closed position to the open position. For example, the controller may process data from the accelerometer to generate a signal indicative of the lid position changing from the closed position to the open position.

In one example, a machine learning model may be used to process data from the accelerometer to generate a signal indicative of the lid position changing from the closed position to the open position.

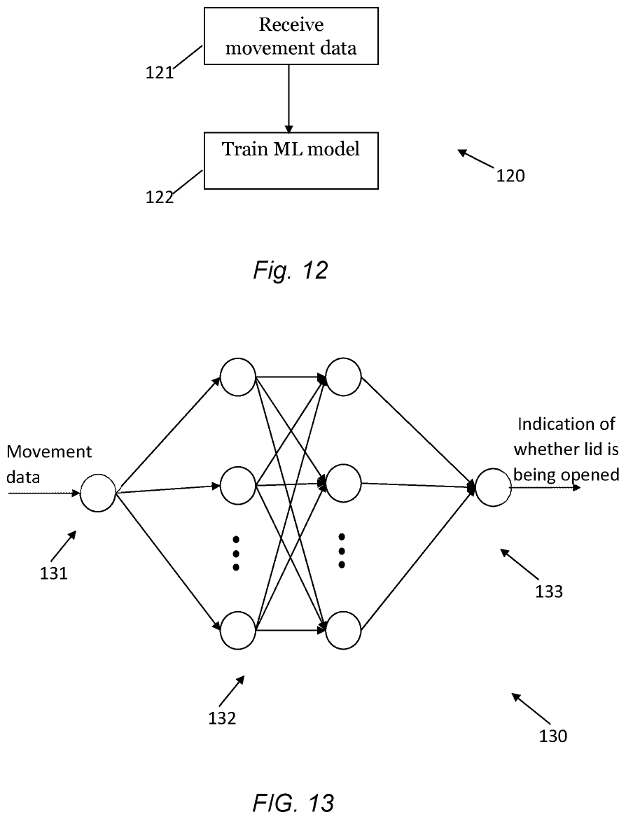

FIG. 12 is a flowchart of an algorithm, indicated generally by the reference numeral 120, in accordance with an example embodiment. At operation 121, movement data so from an accelerometer (42, 51) is received at a processor. At operation 122, a machine learning model is trained using the received movement data.

In one example, in a training stage of the machine learning model, ground truth data, including movement data and an indication of whether the corresponding movement data relates to the lid being opened (or, in some example embodiments, closed), is provided to the machine learning model. In one example, the machine learning model may further be trained during use (inference stage), where the movement data detected by the accelerometer (41, 52) may be stored and used for training of the machine learning model. It may be appreciated that the machine learning model may be trained with generic data from a plurality of users in order to have a high amount of ground truth data, and may additionally be trained for a particular user using movement data specific to the particular user. In one example, different machine learning models (e.g. trained with different ground truth data) may be used for detecting lid movement in a case with the accelerator in the main body, and in a case with the accelerator in the lid. In one example, the machine learning model is a neural network.

FIG. 13 shows a neural network, indicated generally by the reference numeral 130, used in some example embodiments. For example, the machine learning model, as described above with reference to FIG. 12 may comprise the neural network 130. The neural network 130 may be trained with movement data, as obtained from the accelerometer in algorithm 120 with reference to FIG. 12. The neural network 120 comprises an input layer 131, one or more hidden layers 132, and an output layer 133. At the input layer 131, movement data may be received as inputs. The hidden layers 132 may comprise a plurality of hidden nodes, where machine learning modelling may be performed corresponding to the movement data received. At the output layer 133, an indication of whether a lid (such as lid 12) is being opened may be provided as an output. The neural network 130 is provided by way of example only; the skilled person will be aware of many alternative configurations of machine learning models that could be used.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A case for an aerosol delivery device comprising:
a lid having an open position and a closed position;
an accelerometer configured to detect movement indicative of the lid position changing from the closed position to the open position;
a battery status indicator; and
a controller configured to activate the battery status indicator when said signal indicates that the lid position has changed from the closed position to the open position.

2. The case as claimed in claim 1, wherein the controller is configured to receive a signal from the accelerometer indicative of the lid position changing from the closed position to the open position.

3. The case as claimed in claim 1, wherein the accelerometer is provided within the lid of the case.

4. The case as claimed in claim 1, wherein the accelerometer is provided within a main body of the case.

5. The case as claimed in claim 1, wherein the battery status indicator comprises one or more light emitting diodes.

6. The case as claimed inn claim 1, wherein the battery status indicator indicates a charge level of the case.

7. The case as claimed in claim 1, wherein the battery status indicator indicates a charge level of an aerosol delivery device received in the case.

8. The case as claimed in claim 1, wherein the movement indicative of the lid position changing from the closed position to the open position is detected by processing data from the accelerometer.

9. The case as claimed in claim 1, wherein the movement indicative of the lid position changing from the closed position to the open position is detected by processing data from the accelerometer using a machine learning model.

10. The case as claimed in claim 9, wherein the machine learning model is provided as part of the accelerometer.

11. The case as claimed in claim 9, wherein the machine learning model is provided as part of the controller.

12. A method comprising:
receiving movement data from an accelerometer comprised in a case for an aerosol delivery device;
determining whether the movement data are indicative of a lid position changing from a closed position to an open position; and
activating a battery status indicator of the case in the event that the movement data are determined to be indicative of the lid position changing from a closed position to an open position.

13. The method as claimed in claim 12, further comprising receiving or generating a signal from the accelerometer indicative of the lid position changing from the closed position to the open position.

14. The method as claimed in claim 12, wherein the battery status indicator indicates a charge level of the case and/or a charge level of an aerosol delivery device received in the case.

15. The method as claimed in claim 12, further comprising processing data from the accelerometer to generate a signal indicative of the lid position changing from the closed position to the open position.

16. The method as claimed in claim 12, further comprising using a machine learning model to process data from the accelerometer to generate a signal indicative of the lid position changing from the closed position to the open position.

17. A method comprising:
receiving movement data from an accelerometer comprised in a case for an aerosol delivery device; and
training a machine learning model to detect, based on the received movement data, movement indicative of a lid of the case changing from a closed position to an open position,
wherein the case comprises the lid having the open position and the closed position, the accelerometer, a battery status indicator, and a controller to activate the battery status indicator in the event that the movement data are determined to be indicative of the lid position changing from a closed position to an open position.

18. A kit of parts comprising the case as claimed in claim 1, an aerosol delivery device and an article for use in the aerosol delivery device.

19. The kit of parts as claimed in claim 18, wherein the aerosol delivery device is a non-combustible aerosol generating device.

20. The kit of parts as claimed in claim 18, wherein the article is a removable article comprising an aerosol generating material.
